(19) United States
(12) Patent Application Publication
(10) Pub. No.: US 2004/0042504 A1
(43) Pub. Date: Mar. 4, 2004

(54) Aligning data bits in frequency synchronous data channels

(76) Inventors: John Michael Khoury JR., Basking Ridge, NJ (US); Kadaba R. Lakshmikumar, Basking Ridge, NJ (US); Guoqing Miao, Millington, NJ (US)

Correspondence Address: FISH & RICHARDSON P.C., 45 ROCKEFELLER PLAZA, SUITE 2800, NEW YORK, NY, 10111, US

(21) Appl. No.: 10/233,640

(22) Filed: Sep. 3, 2002

(51) Int. Cl. H04J 3/06; H04J 3/04

(52) U.S. Cl. 370/518; 370/536

(57) ABSTRACT

Techniques relating to aligning data bits in frequency synchronous data channels are disclosed. The techniques include determining a phase relationship between clock signals in a pair of data channels. If the clock signals are determined to be out-of-phase, the data bits in a particular one of the data channels may be reordered.

### BACKGROUND

This disclosure relates to aligning data bits in frequency synchronous data channels.

Synchronous transmission refers to the transmission of data at a fixed rate with the transmitter and receiver synchronized to the same clock. Each end of the transmission synchronizes itself with clock information sent with the transmitted data. A typical parallel interface may include an N-bit wide data bus and a clock operating, for example, at the data rate or half the data rate. Such interfaces are sometimes referred to as “source synchronous” because the underlying frequency and phase of the data on each data line from the transmitter to the receiver is locked to the frequency and phase of the accompanying clock signal.

Source synchronous interfaces may provide various advantages, including increased input/output (I/O) frequencies. On the other hand, transmitting the clock signal along with the data often requires excessive and unnecessary power dissipation. Furthermore, various problems related to skew may negatively impact the operation of a source-synchronous system. For example, skew may occur between the data lines such that the data bits arriving on different data lines are not properly aligned. Similarly, skew may occur between the clock signal and the data signals, such that the data signals are not properly captured at the receiver end.

### SUMMARY

The disclosed techniques relate to aligning data bits in frequency synchronous data channels.

The techniques include determining a phase relationship between clock signals in a pair of data channels. If the clock signals are determined to be out-of-phase, the data bits in a particular one of the data channels may be reordered.

According to one aspect, a method includes demultiplexing data bits in data channels, determining a phase relationship between clock signals for a pair of the data channels, and causing the data bits in a particular one of the pair of data channels to be reordered if the clock signals are determined to be out-of-phase.

In a particular implementation, the method may include determining a phase relationship between recovered clock signals for a pair of adjacent data channels. Causing the data bits to be reordered may include rotating a phase of the clock signal in the particular data channel prior to demultiplexing the data bits. Alternatively, the data bits in the particular channel may be reordered following demultiplexing of the data bits in the particular data channel.

In another aspect, a method includes re-timing data signals in a first data channel and in an adjacent data channel based on respective recovered clock signals The method includes identifying which clock signal from among a multiple clock signals in the first data channel has a phase that most closely corresponds to a phase of a clock signal in the adjacent data channel. A phase relationship is determined between the identified clock signal and the clock signal in the adjacent data channel. If the identified clock signal and the clock signal in the adjacent data channel are determined to be out-of-phase, the data bits in a particular one of the data channels may be reordered.

The disclosed methods may be used, for example, in connection with full-rate, half-rate, or 1/M-rate clock and data recovery techniques. Circuitry for implementing the techniques is disclosed as well.

In various implementations, one or more of the following advantages may be present. For example, the techniques may help align the demultiplexer outputs from different data channels. The techniques can be used in communications systems without requiring that clock signals be separately transmitted to the receiver. Therefore, the overall power dissipation can be reduced. Also, potential sources of skew may be eliminated because the receiver need not distribute a high speed recovered clock signal to multiple channels. Furthermore, providing a separate clock and data recovery circuit In each data channel can help optimize the sampling point for each channel and can help maximize the robustness of the receiver and improve the bit error rate performance.

Other features and advantages will be readily apparent from the following detailed description, the accompanying drawings and the claims.

### BRIEF DESCRIPTION OF THE DRAWINGS

FIG. 1A illustrates an example of a clock and data recovery-based source synchronous system.

FIG. 1B is a timing diagram associated with FIG. 1A.

FIG. 2 illustrates further details of a full-rate clock and data recovery (CDR) architecture that uses clock inversion to align data bits at the demultiplexer outputs.

FIG. 3A illustrates an example of a demultiplexer for use in the system of FIG. 2.

FIG. 3B is a timing diagram for FIG. 3A.

FIG. 3C illustrates an example of a circuit to compare clock signals from adjacent channels.

FIG. 4 is a timing diagram associated with FIG. 2.

FIG. 5 illustrates further details of a full-rate CDR architecture that uses data reversal to align data bits at the demultiplexer outputs.

FIG. 6A illustrates an example of a demultiplexer to illustrate details of the system of FIG. 5.

FIG. 6B is a timing diagram for FIG. 6A.

FIG. 7 illustrates a half-rate CDR architecture that uses data reversal to align outputs of the CDR circuits and that uses clock inversion to align data bits at the demultiplexer outputs.

FIG. 8 illustrates a half-rate CDR architecture that uses data reversal to align outputs of the CDR circuits as well as to align data bits at the demultiplexer outputs.

FIGS. 9 and 10 illustrate implementations for aligning data bits in receivers that include 1/M rate CDR circuits.

### DETAILED DESCRIPTION

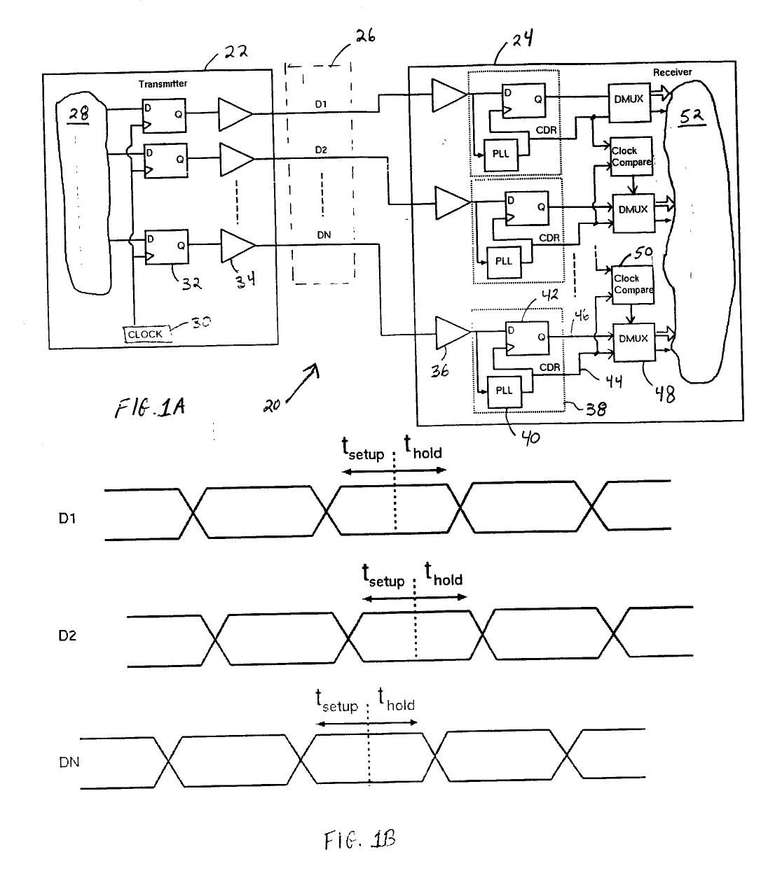

As shown in FIG. 1A, a source synchronous system 20 includes a transmitter 22 and receiver 24. The parallel interface includes N data channels labeled D1, D2, . . . DN, which propagate data from the transmitter to the receiver through a backplane, cable or other transmission medium 26. The transmitter 22 may include circuitry 28 such as a central processing unit (CPU) or other logic. A clock 30 causes flip-flops 32 to latch respective data bits from the circuitry 28 and determines the timing for transmission of the data bits over the data channels D1, D2, . . . DN through drivers 34. The data bits are transmitted synchronously and initially are substantially aligned with one another.

Each data channel D1, D2, . . . DN may be coupled to a respective buffer 36 at the receiver 24. The output of each buffer is coupled to a respective clock and data recovery (CDR) circuit 38. Because each data channel includes its own CDR circuit, a clock signal does not need to be transmitted separately firm the transmitter to the receiver. As illustrated in FIG. 1B, the use of a separate CDR circuit for each data channel can help ensure proper setup and hold times (tₛₑₜᵤₚ, t_{hold}) for each flip-flop 42 to optimize the sampling point for the corresponding data channel. That may improve the robustness and bit error rate performance of the receiver. Although the CDR circuits dissipate power, the power dissipated by the CDR circuits in high speed systems typically may be lower than the buffers required for high speed clocks. Therefore, there may be an overall reduction in power dissipation as well.

Each fill-rate CDR circuit 38 may include, for example, a phase locked loop (PLL) circuit 40 whose output serves as the clock signal for a flip-flop 42. The output of the corresponding buffer 36 is provided as an input to the PLL circuit 40 and as an input to the flip-flop 42. The recovered clock signal and the re-timed data signal may be provided on lines 44, 46, respectively to an associated demultiplxer (DMUX) 48. The demultiplexers may be used to reduce the rate at which the incoming data bits are forwarded to circuitry 52 for further on-chip processing. The circuitry 52 may include, for example, a central processing unit (CPU) or other logic.

To help ensure that the parallel data bits from the demultiplexers 48 are properly synchronized with one another and appear in the proper order, clock compare circuits 50 may be provided. Each clock compare circuit 50 receives at its input a pair of recovered clock signals from adjacent data channels. The phases of the received clock signals are compared and, depending upon the result of the comparison, one of the recovered clock signals may be inverted by rotating the phase of the clock so that the data bits are properly aligned at the output. For example, a particular clock compare circuit 50 compares the recovered clock signals from data lanes j and j+1 to determine the phase relationship of the recovered clock signals. The comparison may be used to align the data in channel j+1 with the data in channel j by assuming that data channel j is the master and data channel j+1 is the slave.

Using the foregoing technique, alignment of the data bits from the demultiplexer outputs may be achieved as follows. Data channel D1, for example, may be considered the master channel. The data bits in channel D2 may be aligned to the data bits in channel D1, the data bits in channel D3 may be aligned to the data bits in channel D2, and so on, until the data bits in channel DN are aligned to the data bits in channel D(N−1).

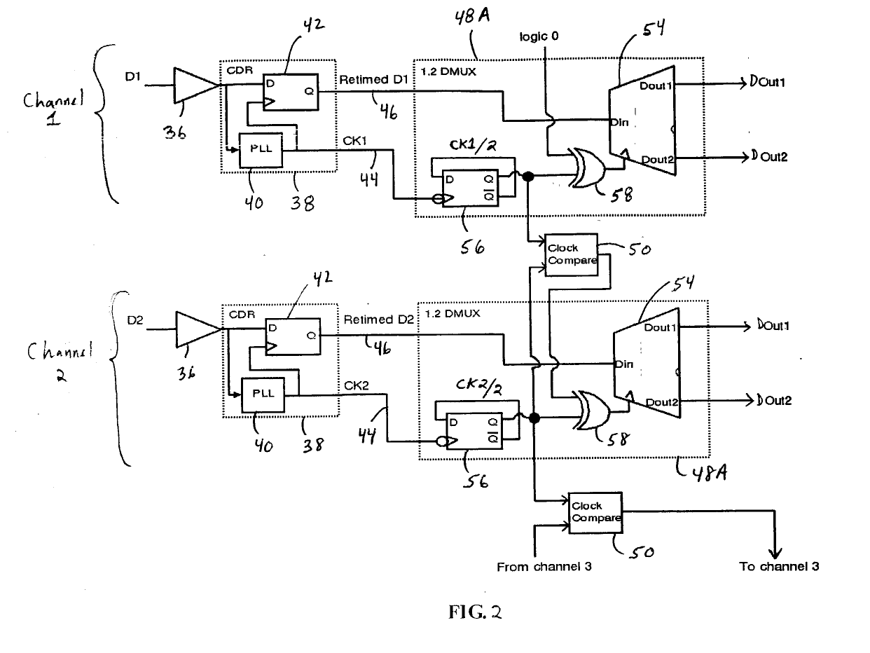

A particular implementation for the data bit alignment technique is illustrated by FIG. 2. To facilitate the description, only adjacent data channels 1 and 2 are shown. In the design of FIG. 2, each CDR circuit 38 uses a full-rate clock, and the retimed data hits are sent to the corresponding 1:2 demultiplexer circuit 48A. Each demultiplexer circuit 48A may include a divide-by-two flip-flop 56 to produce the half-rate clock signal. The trigger signal for the divide-by-two flip-flop 56 is the corresponding recovered clock signal (e.g., CK1 for channel D1, CK2 for channel D2). The output Q of the divide-by-two flip-flop serves as an input to an exclusive-OR gate. For channels other than the master channel, the output from a corresponding one of the clock compare circuits 50 serves as a second input to the exclusive-OR gate. For the master channel (channel 1 in this example), the second input for the exclusive-OR gate is set to a logical “0.”

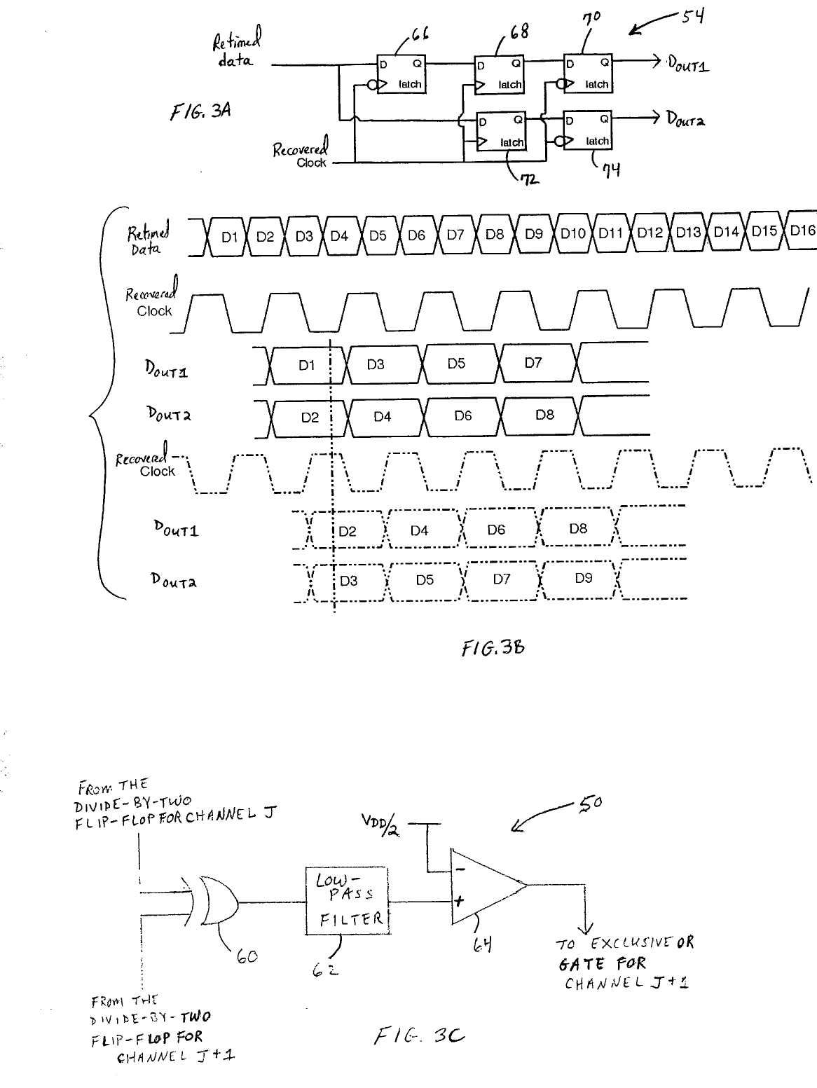

Each circuit 48A includes a 1:2 demultiplexer 54 that receives retimed data signals from the CDR circuit 38 and provides parallel data bits (Dₒᵤₜ₁, Dₒᵤₜ₂) at its output. The demultiplexer 54 is triggered by the half-rate clock signal from the exclusive-OR gate 58. One particular implementation of the 1:2 demultiplxer 54 is illustrated in FIG. 3A. One path includes three latches 66, 68, 70, and a second path includes two latches 72, 74 corresponding, respectively, to the outputs (Dₒᵤₜ₁, Dₒᵤₜ₂). The extra latch in the top branch is used to introduce a delay to align the even and odd data bits at the lower output rate.

Odd data bits (e.g., D1, D3, D5, etc.) may be sampled, for example, at the falling edge of the input clock signal, and even data bits (e.g., D2, D4, D6, etc.) may be sampled at the clock's rising edge, as indicated by the solid lines in the timing diagram of FIG. 3B. If however, the input clock signal is 180 degrees out-of-phase (as indicated by the dotted lines in FIG. 3B), then, in the absence of clock signal inversion, the output data bits at the demultiplexer output would be delayed by half a clock cycle. In that case, the roles of the odd and even data bits would be interchanged such that a different pair of data bits would appear in parallel at the outputs (Dₒᵤₜ₁, Dₒᵤₜ₂) of the demultiplexer 54. For example, instead of the data bits D1, D2, the data bits D2, D3 may appear in parallel at the demultiplxer's output.

The clock compare circuit 50 provides a digital output signal that is received by the exclusive-OR gate 58 in channel j+1 to cause the clock signal for that channel to be shifted by 180 degrees if the clock signals for the corresponding adjacent channels (j and j+1) are out of phase. As illustrated in FIG. 3C, each clock compare circuit 50 may include, for example, an exclusive-OR gate 60, followed by a low-pass filter 62 whose output is compared in a comparator 64 to a predetermined voltage such as V_{DD}/2. The output of the exclusive-OR clock compare circuit will be a digital low voltage signal if the recovered clock signals from adjacent channels are substantially in-phase. If the recovered clock signals are out-of-phase, then the output of the clock compare circuit will be a digital high voltage signal. By applying the output of the clock compare circuit 50 as an input to the exclusive-OR gate 58 for channel j+1, the clock signal for channel j+1 can be inverted prior to being applied to the demultiplexer 54 if the clock signal is not substantially in phase with the clock signal for the adjacent channel j.

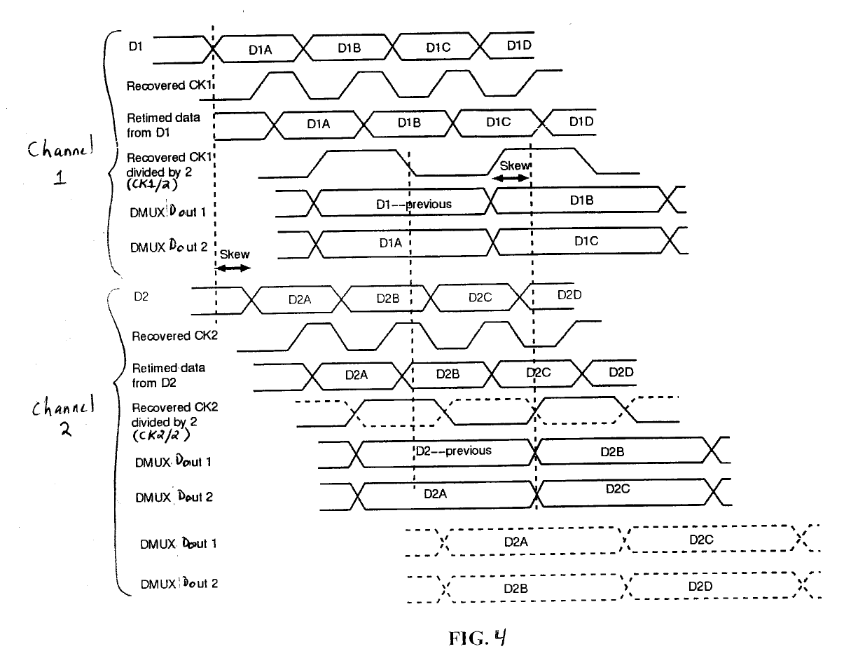

FIG. 4 illustrates a timing diagram for the circuit of FIG. 2. In addition to skew that may be present between the data bits in the two channels, the reduced rate clock (i.e., half-rate clock) signals may be out-of-phase. The out-of-phase reduced rate clock signal (CK2/2) for channel 2 is indicated by dotted lines, whereas the in-phase reduced rate clock signal for channel 2 is indicated by a solid line. If the reduced rate clock signals are in-phase, then the data bits D1B, D1C from the demultiplexer in the first channel will 20 be aligned with the data bits D2B, D2C from the demultiplexer in the second channel (compare Dₒᵤₜ₁ and Dₒᵤₜ₂ for channel 1 to the solid lines for D_{out 1} and Dₒᵤₜ₂ in channel 2 in FIG. 4). On the other hand, in the absence of the clock compare circuit 50, if the reduced rate clock signals are out-of-phase, then the data bits D1B, D1C From the demultiplexer in the first channel would be aligned incorrectly either with the data bits D2A, D2B or D2C, D2D from the demultiplexer in the second channel (see dotted lines for Dₒᵤₜ₁ and Dₒᵤₜ₂ in channel 2). As explained above, if the clock compare circuit detects that the reduced rate clock signals are not aligned, the corresponding exclusive-OR gate 50 will cause the reduced rate clock signal (CK2/2) for channel 2 to be rotated, in this case inverted, before it is applied to the associated demultiplexer 54.

Although FIGS. 1 and 2 illustrate only a single stage of demultiplexers 54 for each data channel, some implementations may include additional demultiplexer stages. For example, if the data bits are transmitted at a high rate of about 10 gigabits per second (Gbit/s), it may be desirable to demultiplex the incoming data bits so that sixteen-bit words can be processed by the circuitry 52 at a slower rate of about 622 megabits per second (Mbit/s). In that case, a total of four demultiplexer stages may be used.

The parallel data bits obtained from the subsequent stages of demultiplexers, however, may not be aligned if the clock signals driving the demultiplexers are not synchronized. Therefore, clock compare circuits and corresponding exclusive-OR gates may be provided at each stage of demultiplexers, as described above, to help ensure that the data bits are properly aligned at the output of each stage. On the other hand, the original skew (if any) between the D1 and D2 data channels becomes a smaller percentage of the data period at the lower data rates. Once an adequate timing margin is obtained, a single clock source may be used to retime all the demultiplexed data channels by distributing the slower clock signal from one channel to the remaining channels. Therefore, it may be sufficient in some implementations to provide clock compare circuits and exclusive-OR gates for the first few stages of demultiplexers only.

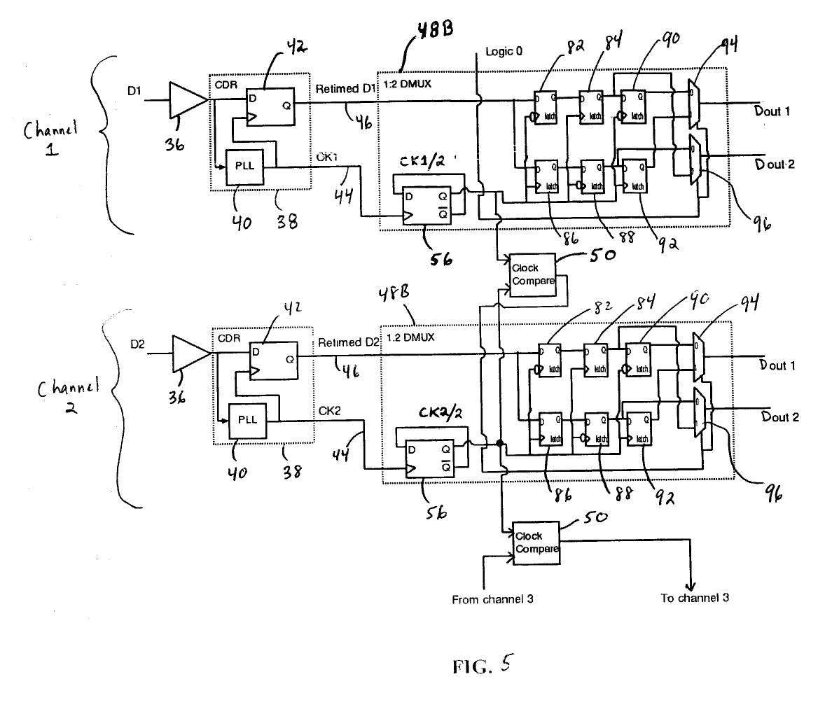

As discussed above, in some implementations, the clock signal for a particular channel j+1 is inverted prior to being applied to the demultiplexer if the clock signal is not aligned to the clock signal for the adjacent channel j. In other implementations, discussed below in connection with FIG. 5, instead of rotating (e.g., inverting) the clock signal, the order of the demultiplexed data bits may be rearranged to obtain the proper alignment.

Although there may be more than two channels, only adjacent data channels 1 and 2 are shown in FIG. 5. In the design of FIG. 5, each CDR circuit 38 uses a full rate clock, and the re-timed data bits are sent to the corresponding 1:2 demultiplexer circuit 48B. Each demultiplexer circuit 48B may include a divide-by-two flip-flop 56 to produce the half-rate clock signal. The output Q of the flip-flop 56 serves as the clock signal for data paths formed by pairs of cascaded latches 82, 84, 86, 88, 90 and 92.

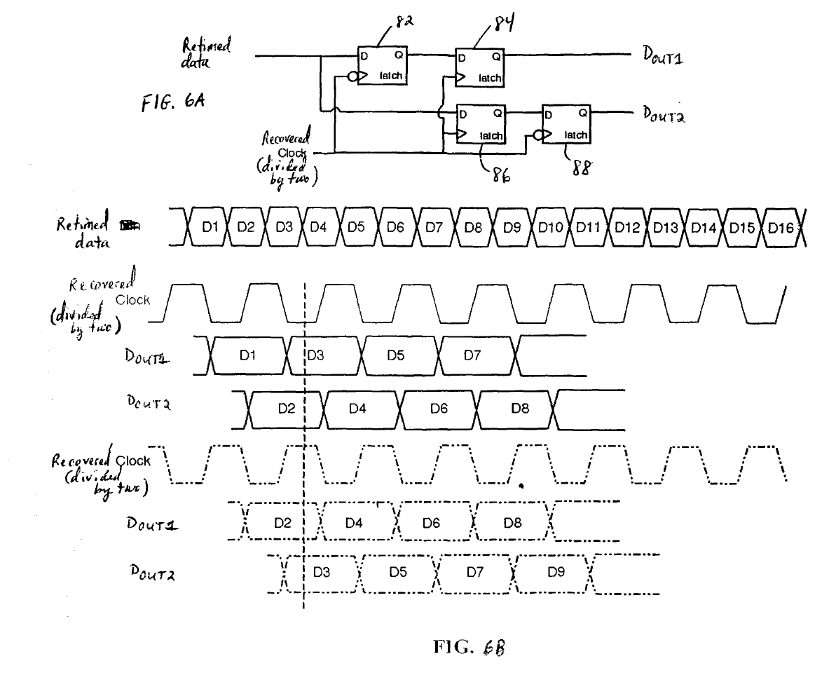

The latches 82, 84, 86, 88, 90 and 92 provide a demultiplexing function for the re-timed data bits. As illustrated in FIG. 6A, both branches of the demultiplexer include a pair of latches. The odd data bits (e.g., D1, D3, D5, etc.) may be sampled, for example, at the falling edge of the clock signal, and the even data bits may be sampled at the rising edge. The clock signals are inverted prior to being applied to the latches 82, 88. The result is that the odd bits and even bits are separated at the output as indicated by the solid lines for the signals D_{OUT1} and D_{OUT2} in FIG. 6B. If, however, the clock waveform is 180 degrees out of phase, as shown by the dotted lines for the recovered clock signal in FIG. 6B, then the odd and even data bits will be interchanged, with the even bits appearing as D_{OUT1} and the odd bits appearing as D_{OUT2}. As indicated by the vertical dotted line in FIG. 6B, there is only a small time interval during which the data bits D2 and D3 appear simultaneously, making it difficult to retime both sets of data bits with a single clock. Therefore, the demultiplexed data bits appearing as D_{OUT1} and D_{OUT2} may need to be realigned to improve the timing margin.

To allow the demultiplexed data bits to be realigned, additional latches 90, 92 (FIG. 5) are used to introduce a predetermined delay of a half-period to the paths for the data bits. The delayed versions of the data bits are provided as inputs to a first selector switch 94. The non-delayed versions of the data bits are provided as inputs to a second selector switch 96 with the paths for the data bits crossed.

The output of a corresponding clock compare circuit 50 serves as the control signal for the selector switches and determines whether the odd and even data bits are to be interchanged and into which branch of the multiplexer the delay should be inserted. In the illustrated implementation, a logical “0” signal causes the half period delay to be inserted into the top branch without crossing the data bit paths, whereas a logical “1” signal crosses the paths.

For channels other than the master channel, the output form the corresponding clock compare circuit 50 serves as the control signal for selector switches 94, 96. For the master channel (channel 1 in this example), the control signal for the selector switches may be set to a logical “0”.

Each clock compare circuit 50 in FIG. 5 receives as its input a pair of reduced rate clock signals from adjacent channels. The clock compare circuit 50 provides a digital output signal indicative of whether the clock signals are substantially in-phase or out-of-phase. The circuit of FIG. 3C may be used for the clock compare circuits 50 in FIG. 5. According to that implementation, the output of the clock compare circuit will be a digital low voltage signal if the recovered clock signals from adjacent channels are substantially in-phase. In that case, the output signal from the clock compare circuit causes the half period delay to be inserted into the top branch of the demultiplexer without crossing the data bit paths if the recovered clock signals are out-of-phase, then the output of the clock compare circuit will be a digital high voltage signal. In that case, the output signal from the clock compare circuit causes the half period delay to be inserted into the bottom branch of the demultiplexer with the data paths crossed.

Therefore, the circuit of FIG. 5 can be used to align the data bits in adjacent channels. Assuming, for example, that channel 1 is the master channel, the data bits for channel 2 would be aligned with the data bits for channel 1. Next, the data bits for channel 3 would be aligned with the data bits for channel 2, and so on, until the data bits for channel N are aligned with the data bits for channel N−1.

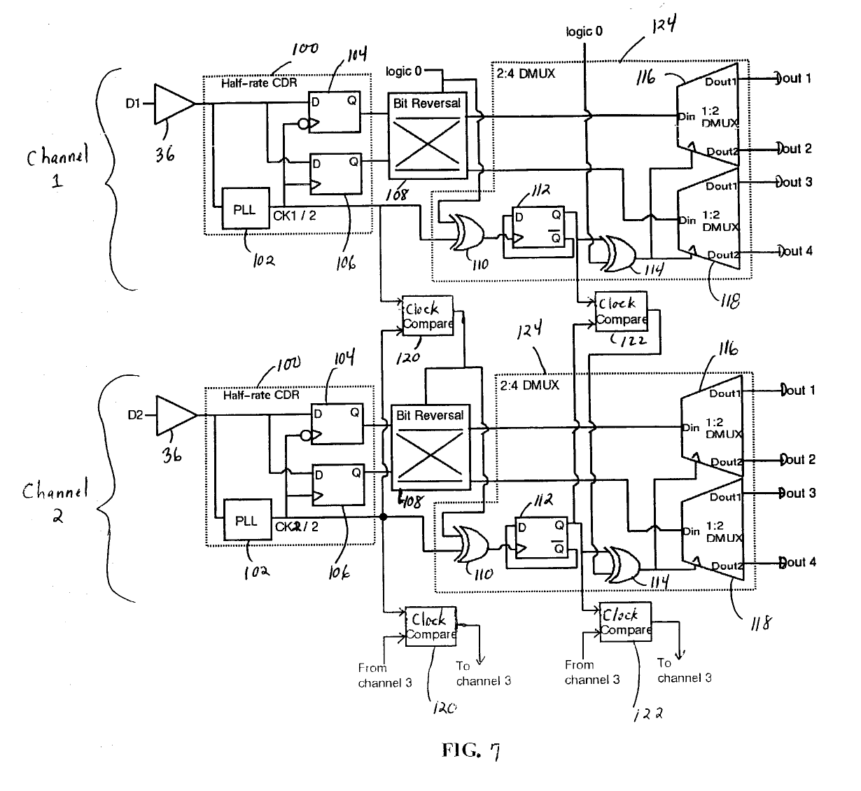

The foregoing techniques of rotating the clock signal and reordering the data bits can be used with half-rate CDR circuits as well as with full-rate CDR circuits. FIG. 7 illustrates an implementation using half-rate CDR circuits 100 in which reordering the data bits may be used to align the demultiplexed outputs from the CDR circuits in adjacent channels, and rotating (e.g., inverting) the clock signal may be used, when necessary, to align the demultiplexer outputs in adjacent channels.

Each half-rate CDR circuit 100 may include a PLL circuit 102 whose output serves as the trigger signal for a pair of flip-flops 104, 106. The recovered clock signal is inverted prior to being applied to one of the flip-flops, in this example flip-flop 104. In a half-rate architecture, the recovered clock signals in adjacent channels may be 180 degrees out of phase, in addition to the original data skew (if any) between the data channels. Therefore, a clock compare circuit 120, which may be similar to the clock compare circuit of FIG. 3C, compares the relative phases of the recovered clock signals from adjacent channels j and j+1. If the clock signals are out-of-phase, then bit reversal logic 108 at the output of the CDR circuit 100 in channel j+1 rearranges the data bits in that channel to match the ordering in channel j. Additionally, using the exclusive-OR gate 110 preceding the divide-by-two flip-flop 112 in the demultiplexer circuit 124, the phase of the half-rate clock in channel j+1 may be shifted by 180 degrees to match the alignment of channel j.

The 2:4 demultiplexer circuits 124 may introduce uncertainty as a result of the clock divider circuitry 112. Another clock compare circuit 122 may be used to determine the phase relationship of the reduced rate clock signals from the divide-by-two flip-flops 112 in adjacent channels j and j+1. The output of the clock compare circuit 122 is provided to the exclusive-OR gate 114 in channel j+1. As previously described, the exclusive-OR gate functions to invert the clock signal driving the demultiplexers 116, 118 in channel j+1 if the output signal from the clock compare circuit 122 indicates that the clock signal for that channel is out-of-phase with respect to the clock signal for channel j.

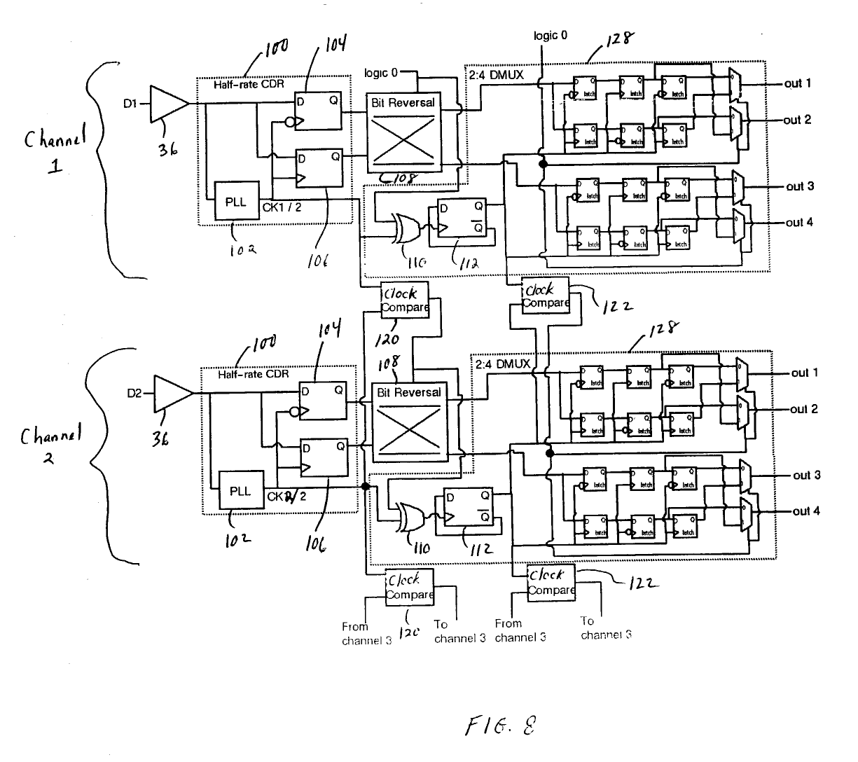

In another half-rate CDR implementation illustrated in FIG. 8, data reversal may be used to align the outputs from the CDR circuits 100 as well as to align the demultiplexer outputs at the demultiplexer circuits 128. In other words, instead of inverting the clock signal to align the demultiplexer outputs, data reversal may be used as described in connection with FIG. 5. For example, in each 2:4 demultiplexer 128 in FIG. 8, the output of the divide-by-two flip-flop 112 may be coupled to sets of latches as described in connection with FIG. 5. Furthermore, the output of the clock compare circuit 122 that compares the clock signals for channels j and j+1 may be coupled to pairs of selector switches in the demultiplexer circuit 128 for channel j+1 as described in connection with FIG. 5.

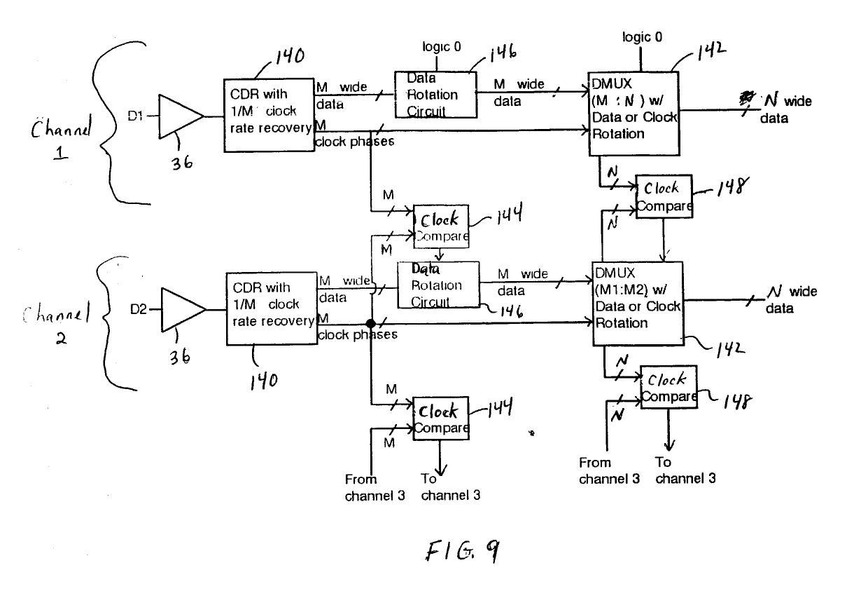

FIG. 9 illustrates a generalized architecture in which each CDR circuit 140 operates at a rate 1/M of the incoming data rate and is followed by a M:N demultiplexer circuit 142, where M<N. For example, in one implementation, M may equal eight and N may equal sixteen. Clock compare circuits 144 compare multiple clock phases instead of a single clock phase. At the output of the CDR circuits 140 for channels j and j+1, the clock signal for phase 1 of channel j would be compared to each clock phase 1, 2, . . . M of channel j+1. The output of the clock compare circuit 144 would indicate which phase of the channel j+1 clock signals corresponds, for example, to phase 1 of channel j. A data bit rotation circuit 146, which may be implemented, for example, as a barrel shifter, would then rotate the data bits received as output from the CDR circuit 140 for channel j+1 by the number of positions that the clock phases for channels j and j+1 differ.

Clock compare circuits 148 provide an output indicative of which one of the N clock phases in channel j+1 resulting from the demultiplexing by the M:N demultiplexer circuit 142 corresponds, for example, to phase 1 of channel j. The demultiplexer 142 in channel j+1 may perform either a clock rotation function analogous to that described in connection with FIG. 2, where a rotation of 180 degrees is performed, or a data bit rotation and delay adjustment analogous to that described in connection with FIG. 5.

The clock phases for each pair of adjacent channels may be compared sequentially using one of the channels, such as channel 1, as the master channel. Thus, for example, the data bits of channel 2 may be aligned to those of channel 1, the data bits of channel 3 then may be aligned to those of channel 2, and so, until the data bits of all channels are aligned.

As mentioned above, the receiver may include multiple stages at which the data bits in each channel are demultiplexed. A comparison of the clock signal phases may be made at each stage followed by either the use of clock rotation or data bit rotation so that the data bits remain properly aligned at each stage.

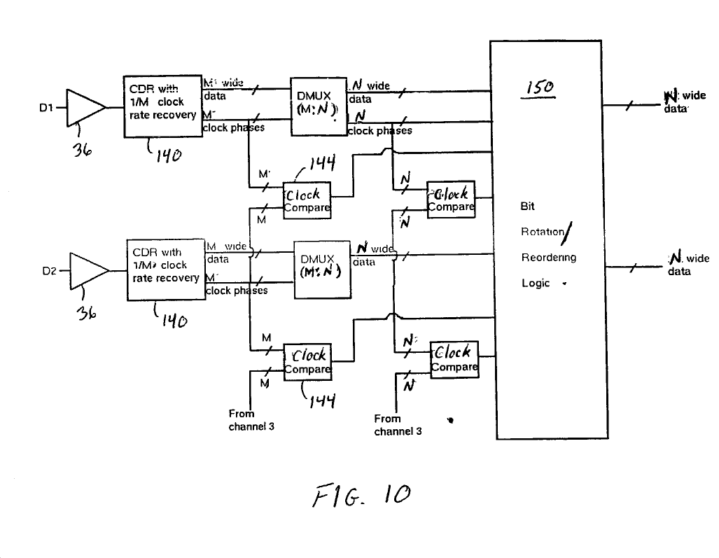

Alternatively, as shown in FIG. 10, only the clock signal phase comparisons may be made at each stage. The results of the clock signal phase comparisons of all stages would be used by circuitry 150 to perform the clock rotation or data bit rotation at a final stage. One advantage of such a technique is that the bit reordering may be performed at the lower frequency of the final stage.

Other implementations are within the scope of the claims.

What is claimed is:

1. A method comprising:
demultiplexing data bits in a plurality of data channels;
determining a phase relationship between clock signals for a pair of the data channels; and
causing the data bits in a particular one of the pair of data channels to be reordered if the clock signals are determined to be out-of-phase.

2. The method of claim 1 wherein causing the data bits to be reordered includes rotating a phase of the clock signal in the particular data channel prior to demultiplexing the data bits.

3. The method of claim 1 wherein causing the data bits to be reordered includes reordering the data bits for the particular channel following demultiplexing of the data bits in the particular data channel.

4. A method comprising:
determining a phase relationship between recovered clock signals for a pair of adjacent data channels;
demultiplexing data bits in each of the data channels; and
causing the data bits in a particular one of the data channels to be reordered if the clock signals are determined to be out-of-phase.

5. The method of claim 4 wherein causing the data bits to be reordered includes rotating a phase of the clock signal in the particular data channel prior to demultiplexing the data bits.

6. The method of claim 4 wherein causing the data bits to be reordered includes reordering the data bits for the particular channel following demultiplexing of the data bits in the particular data channel.

7. The method of claim 6 including introducing a predetermined delay into a selected branch of the demultiplexed data bits for the particular data channel based oil the phase relationship.

8. A method comprising:
receiving data bits over a plurality of data channels;
recovering a respective clock signal for each data channel based oil the data bits received for that channel;
reducing a rate of the recovered clock signals;
providing a signal indicative of a phase relationship of the reduced rate clock signals of a pair of adjacent channels;
rotating a phase of the reduced rate clock signal of a particular one of the pair of adjacent channels if the signal indicative of the phase relationship indicates that the reduced rate clock signals are out-of-phase; and
demultiplexing data bits in the data channels based on the reduced rate clock signals, wherein the re-timed data bits in the particular channel are demultiplexed using the reduced rate clock signal with the adjusted phase if the signal indicative of the phase relationship indicates that the reduced rate clock signals are out-of-phase.

9. The method of claim 8 wherein rotating a phase of the reduced rate clock signal includes inverting the phase of the reduced rate clock signal.

10. The method of claim 8 wherein there are at least three data channels, the method including providing a signal indicative of a phase relationship of the reduced rate clock signals of adjacent channels and performing said rotating for each pair of adjacent channels.

11. The method of claim 10 wherein three at least three channels one of which is considered a master channel, the method including providing a signal indicative of a phase relationship of the reduced rate clock signals of adjacent channels and performing said rotating for each pair of adjacent channels to align the demultiplexed data hits for each of the channels with the demultiplexed data bits for the master channel.

12. The method of claim 8 including re-timing the received data bits in each data channel using a corresponding one of the recovered clock signals, wherein demultiplexing includes demultiplexing the re-timed data bits.

13. A method comprising:
receiving data bits over a plurality of data channels;
recovering a respective clock signal for each data channel based on the data bits received for that channel;
reducing a rate of the recovered clock signals;
demultiplexing data bits in the data channels using the reduced rate clock signals;
providing a signal indicative of a phase relationship of the reduced rate clock signals of a pair of adjacent channels; and
reordering the demultiplexed data bits in a particular one of the pair of adjacent data channels if the signal indicative of a phase relationship indicates that the reduced rate clock signals are out-of-phase.

14. The method of claim 13 including introducing a predetermined delay into a selected branch of demultiplexed data bits in the particular data channel based on the signal indicative of the phase relationship.

15. The method of claim 13 wherein there are at least three data channels, the method including providing a signal indicative of a phase relationship of the reduced rate clock signals of adjacent channels and performing said reordering for each pair of adjacent data channels.

16. The method of claim 13 wherein there are at least three data channels one of which is considered a master channel, the method including providing a signal indicative of a phase relationship of the reduced rate clock signals of adjacent channels and performing said reordering for each pair of adjacent data channels to align the demultiplexed data bits for each of the channels with the demultiplexed data bits for the master channel.

17. The method of claim 13 including re-timing the received data bits in each data channel using a corresponding one of the recovered clock signals, wherein demultiplexing includes demultiplexing the re-timed data bits.

18. An apparatus comprising:
a plurality of data channels;
a respective clock and data recovery circuit for each data channel to provide retimed data bits based on a recovered clock signal for that data channel;
circuitry to reduce a rate of the recovered clock signal for each data channel;
circuitry to receive the reduced rate clock signals for a pair of adjacent data channels and to provide a signal indicative of a phase relationship between the reduced rate clock signals for the pair of adjacent data channels;
circuitry to rotate the reduced rate clock signal for a particular one of the pair of adjacent data channels, if the signal indicative of the phase relationship indicates that the reduced rate clock signals for the pair of adjacent data channels are out-of-phase; and
circuitry to demultiplex the re-timed data bits for each data channel according to the reduced rate clock signals, wherein the re-timed data bits in the particular data channel are demultiplexed according to the rotated reduced rate clock signal of the signal indicative of the phase relationship indicates that the reduced rate clock signals for the pair of adjacent data channels are out-of-phase.

19. The apparatus of claim 18 wherein the circuitry to provide a signal indicative of the phase relationship includes:
an exclusive-OR gate to receive the reduced rate clock signals for the pair of adjacent data channels.

20. The apparatus of claim 18 wherein the circuitry to rotate the reduced rate clock signal for a particular one of the pair of adjacent data channels includes:
an exclusive-OR gate to receive the reduced rate clock signal for the particular data channel and the signal indicative of the phase relationship.

21. The apparatus of claim 18 including:
circuitry to provide a respective signal indicative of a phase relationship between the reduced rate clock signals for each pair of adjacent data channels; and
circuitry to rotate the reduced rate clock signal of a particular one of a pair of adjacent data channels if the respective phase relationship signal indicates that the reduced rate clock signals are out-of-phase.

22. The apparatus of claim 21 wherein:
the circuitry to provide a respective signal indicative of a phase relationship includes exclusive-OR gates each of which is for receiving the reduced rate clock signals for a respective pair of adjacent data channels; and
circuitry to rotate the reduced rate clock signal of a particular one of a pair of adjacent data channels includes exclusive-OR gates each of which is for receiving the reduced rate clock signal for a particular data channel and a respective signal indicative of the phase relationship.

23. The apparatus of claim 18 wherein each clock and data recovery circuit comprises a full-rate clock and data recovery circuit.

24. The apparatus of claim 18 wherein each clock and data recovery circuit comprises a half-rate clock and data recovery circuit.

25. An apparatus comprising:
a plurality of data channels;
a respective clock and data recovery circuit for each data channel to provide retimed data bits based on a recovered clock signal for that data channel;
circuitry to reduce a rate of the recovered clock signal for each data channel;
circuitry to receive the reduced rate clock signals for a pair of adjacent data channels and to provide a signal indicative of a phase relationship between the reduced rate clock signals for the pair of adjacent data channels;
circuitry to demultiplex re-timed data bits for each data channel according to the reduced rate clock signals; and
circuitry to reorder the demultiplexed data bits in a particular one of the pair of adjacent data channels if the signal indicative of the phase relationship indicates that the reduced rate clock signals for the pair of adjacent data channels are out-of-phase.

26. The apparatus of claim 25 including circuitry to introduce a predetermined delay into a selected branch of demultiplexed data bits in the particular data channel based on the signal indicative of the phase relationship.

27. The apparatus of claim 25 wherein the circuitry to provide a signal indicative of the phase relationship includes:
an exclusive-OR gate to receive the reduced rate clock signals for the pair of adjacent data channels.

28. The apparatus of claim 27 wherein the circuitry to reorder the demultiplexed data bits includes:
latches to introduce a predetermined delay in paths for the demultiplexed data bits; and
a first selector switch to receive the re-timed, demultiplexed data bits through the latches; and
a second selector switch coupled to receive the re-timed, demultiplexed data bits from paths that bypass the latches, wherein the demultiplexed data bits are provided as inputs to the second selector switch in a reverse order compared to an order the data bits are provided as inputs to the first selector switch,
wherein the signal indicative of the phase relationship controls a respective state of each selector switch.

29. The apparatus of claim 25 including:
circuitry to provide a respective signal indicative of a phase relationship between the reduced rate clock signals for each pair of adjacent data channels; and
circuitry to reorder the demultiplexed data bits in a particular one of a pair of adjacent data channels if the respective phase relationship signal indicates that the reduced rate clock signals are out-of-phase.

30. The apparatus of claim 25 wherein each clock and data recovery circuit comprises a full-rate clock and data recovery circuit.

31. The apparatus of claim 25 wherein each clock and data recovery circuit comprises a half-rate clock and data recovery circuit.

32. An apparatus comprising:
a plurality of data channels;
a respective clock and data recovery circuit for each data channel to provide retimed data bits based on a recovered clock signal for that data channel;
means for reducing a rate of the recovered clock signal for each data channel;
means for receiving the reduced rate clock signals for a pair of adjacent data channels and to provide a signal indicative of a phase relationship between the reduced rate clock signals for the pair of adjacent data channels;
means for rotating the reduced rate clock signal for a particular one of the pair of adjacent data channels, if the signal indicative of the phase relationship indicates that the reduced rate clock signals for the pair of adjacent data channels are out-of-phase; and
means for demultiplexing the re-timed data bits for each data channel according to the reduced rate clock signals, wherein the re-timed data bits in the particular data channel are demultiplexed according to the inverted reduced rate clock signal of the signal indicative of the phase relationship indicates that the reduced rate clock signals for the pair of adjacent data channels are out-of-phase.

33. An apparatus comprising:
a plurality of data channels;
a respective clock and data recovery circuit for each data channel to provide re-timed data bits based on a recovered clock signal for that data channel;
means for reducing a rate of the recovered clock signal for each data channel;
means for receiving the reduced rate clock signals for a pair of adjacent data channels and to provide a signal indicative of a phase relationship between the reduced rate clock signals for the pair of adjacent data channels;
means for demultiplexing re-timed data bits for each data channel according to the reduced rate clock signals; and
means for reordering the demultiplexed data bits in a particular one of the pair of adjacent data channels if the signal indicative of the phase relationship indicates that the reduced rate clock signals for the pair of adjacent data channels are out-of-phase.

34. A method comprising:
re-timing data signals in a first data channel and in an adjacent data channel based on respective recovered clock signals;
identifying which clock signal from among a plurality of clock signals in the first data channel has a phase that most closely corresponds to a phase of a clock signal in the adjacent data channel;
determining a phase relationship between the identified clock signal and the clock signal in the adjacent data channel;
rotating an order of the data bits in a particular one of the data channels if the identified clock signal and the clock signal in the adjacent data channel are determined to be out-of-phase.

35. The method of claim 34 wherein rotating the order of the data bits for the particular one of the data channels includes rotating the data bits by a number of bit positions by which a phase for the identified clock signal and a phase for the clock signal in the adjacent data channel differ.

36. An apparatus comprising:
means for determining a phase relationship between recovered clock signals for a pair of adjacent data channels in a receiver;
means for demultiplexing data bits in each of the data channels; and
means for causing the data bits in a first one of the channels to be substantially aligned with data bits in a second one of the channels according to the determined phase relationship.
